(19) United States
(12) Patent Application Publication
(10) Pub. No.: US 2024/0161561 A1
(43) Pub. Date: May 16, 2024

(54) System and Method for Charging and Updating Personal Electronic Equipment

(71) Applicant: Florence Corporation, Manhattan, KS (US)

(72) Inventor: Michael R. Molt, Manhattan, KS (US)

(73) Assignee: Florence Corporation, Manhattan, KS (US)

(21) Appl. No.: 18/509,896

(22) Filed: Nov. 15, 2023

Related U.S. Application Data
(60) Provisional application No. 63/425,770, filed on Nov. 16, 2022.

(51) Int. Cl. G07C 9/00; G06F 8/65; H02J 7/00

(52) U.S. Cl. CPC G07C 9/00912; G06F 8/65; G07C 9/00571; H02J 7/0044

(57) ABSTRACT

A system for charging and updating personal electronic equipment (PEE) comprises an array of lockers with each locker having a door, a lock associated with each door, a power outlet located in each locker for providing electrical power to a piece of PEE in the locker, a data outlet port located in each locker for providing data and software to a select piece of PEE in the locker, and a central control unit adapted to control each of the locks on the array of lockers. The central control unit also has a data output portion for sending data and software through the data outlet port in the select locker to the select PEE in the locker while the associated door for that locker is closed.

### CROSS REFERENCE TO RELATED APPLICATION

This patent application claims the benefit of, and priority to, U.S. Provisional Patent Application No. 63/425,770, filed Nov. 16, 2022, which is incorporated by reference herein in its entirety.

### TECHNICAL FIELD

The present disclosure relates to a system and method for charging and updating the data or software on personal electronic equipment such as lap top or desk computers, tablet computers and smart phones (hereinafter PEE) including an array of lockers that provide efficiencies for users of the system.

### BACKGROUND

Large organizations, such as corporations, government entities and schools, may have many individual users of PEE. The organization has a strong interest in seeing that its users of the PEE have the necessary software to perform their tasks efficiently and the latest versions of that software installed on the PEE for many reasons, including consistency throughout the organization and having the latest anti-spam software to protect the organization's data and internal and external communications. Many organizations also offer PEE with selected software to new employees, agents and students. Each new employee, agent or student must have its computer, tablet or smart phone loaded with the appropriate software prior to or shortly after commencing employment in order to become a contributing member of the organization. Organizations often have a department with multiple employees whose main function is purchasing, monitoring and maintaining the latest software on its members' PEE.

Accordingly, many large organizations have an interest in a system and method for the efficient charging and updating the data or software on multiple units of PEE. They also have an interest in doing this in a limited footprint and during non-standard working hours of the day. The system described here helps address these and other problems and provides an array of lockers, or locker bank, associated electrical equipment and controls for the efficient charging and updating the software on a variety of equipment.

### SUMMARY OF THE DISCLOSURE

A system for charging and updating personal electronic equipment (PEE) comprises an array of lockers with each locker having an interior space defined by a floor, ceiling, a rear end wall, first and second side walls and a door hingedly connected to the first side wall, a lock in one side wall associated with each door for allowing the door to open when in the unlocked state and remain closed in the locked state, a power outlet located in each locker for providing electrical power to a piece of PEE in the locker, a data outlet port located in each locker for providing data and software to a select piece of PEE in the locker; and a central control unit adapted to control each of the locks on the array of lockers with the central control unit having a data output portion for sending data and software through the data outlet port in the select locker to the select PEE in the locker while the associated door for that locker is closed.

In one embodiment, the central control unit of the system also has a data input portion for receiving data on the select piece of PEE in the select locker.

In one embodiment, the array of lockers has an air circulator to provide ambient air to each of the lockers in the array, including a fan, a central air duct, one side wall of each locker having an inlet opening to allow ambient air ingress into the locker, and the rear end wall of each locker having an outlet opening to allow air egress to the surrounding environment to cool a piece of PEE in the locker.

The invention also provides an array of lockers comprising two columns of lockers and a central air duct between the columns and a lower air space below the lowest locker in each column, with each locker having an interior space defined by a floor, ceiling a rear end wall, first and second side walls and a door hingedly connected to the first side wall, a lock in the second side wall associated with each door for allowing the door to open when in the unlocked state and remain closed in the locked state, an electrical power outlet located in one side wall of each locker, a data outlet port also located in one side wall of each locker, an air inlet opening in one side wall of each locker and an air outlet opening in each rear end wall of each locker, and a fan in the central air duct for circulating air from the lower air space, through the central air duct and into each locker through each locker air inlet opening.

The invention also provides a method of charging and updating the data and software on select personal electronic equipment (PEE) in a select locker comprising providing an array of lockers with each locker having an interior space defined by a floor, a ceiling, a rear end wall, first and second side walls and a door hingedly connected to the first side wall, a lock in the second side wall associated with each door for allowing the door to open when in the unlocked state and remain closed in the locked state, a power outlet located in each locker for providing electrical power to a piece of PEE in the locker, a data outlet port located in each locker for providing data and software to a select piece of PEE in the locker, and a central control unit adapted to control each of the locks on the array of lockers, the central control unit also having a data input portion and a data output portion for sending data and software through the data outlet port in a select locker to a select PEE in a select locker while the associated door for that locker is closed, Advising the input portion of the central control unit of a select PEE in need of updated software or data, the central control unit unlocking the door of a select locker, inserting the select PEE into the select locker and connecting it to the power outlet and the data outlet port in that locker, and closing the door.

Further and alternative aspects and features of the disclosed system, method and principles will be appreciated from the following detailed description and the accompanying drawings. As will be appreciated, the system and principles disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of one embodiment of an array of lockers for the system for charging and updating personal electronic equipment.

FIG. 2 is a perspective view of one embodiment of an array of lockers for the system for charging and updating personal electronic equipment with some of the doors in the open, unlocked, condition.

FIG. 3 is an elevation view of four lockers of one column of lockers showing the power and data outlets mounted on one side wall of each locker and the doors in the open, unlocked condition.

FIG. 4 is a front perspective exploded view of a first embodiment of a locker bank highlighting an air circulator associated with the bank of lockers that is mounted on a lower panel or door.

FIG. 5 is a rear perspective view the bank of lockers showing air circulation gratings for each locker.

FIG. 6 is a front perspective view of the bank of lockers with one column of lockers having the doors opened to show the air circulation gratings and locks on one side wall of each locker.

FIG. 7 is stylized front perspective view of the array of lockers showing one subassembly of power and data outlets that can be installed in one column of lockers.

FIG. 8 is a more detailed perspective view a portion of the subassembly of power and data ports shown in FIG. 7, with one power and data module exploded and the back wall of the subassembly exploded.

FIG. 9 is perspective view of the bottom portion of the bank of lockers with the bottom door removed showing the power distribution and circuit breaker unit.

FIG. 10 is a perspective view of the power distribution and circuit breaker unit.

FIG. 11 is a top view of the power distribution and circuit-breaking unit with the cover removed.

FIG. 12 is a cut away perspective view of a portion of the array of lockers showing the data distribution module in a stylized position in the air duct between the two columns of lockers.

FIG. 13 is a perspective view of the bottom portion of a second embodiment of an array of lockers with the lower panel or door in the partially open position.

FIG. 14A is a perspective view of the back side of a lower panel or door associated with a second embodiment of the array of lockers.

FIG. 14B is a perspective view of an air circulator associated with a second embodiment of the array of lockers..

FIG. 15 is a partial cutaway perspective view of the lower portion of the array of lockers showing an air circulator in the air duct.

FIG. 16A is a stylized elevation view of a locker column with a kiosk having an operator interface.

FIG. 16B is a stylized elevation view of a locker column having larger size lockers.

FIG. 16C is a stylized elevation view of a locker column having one larger and primarily smaller lockers.

FIG. 17 is a block diagram illustrating a central control unit with a control module.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice versa without limiting the scope of the disclosure to the exact number or type of such elements unless set forth explicitly in the appended claims. The terms configured and configuration may be used herein to refer to a specified arrangement, or a structural size and shape.

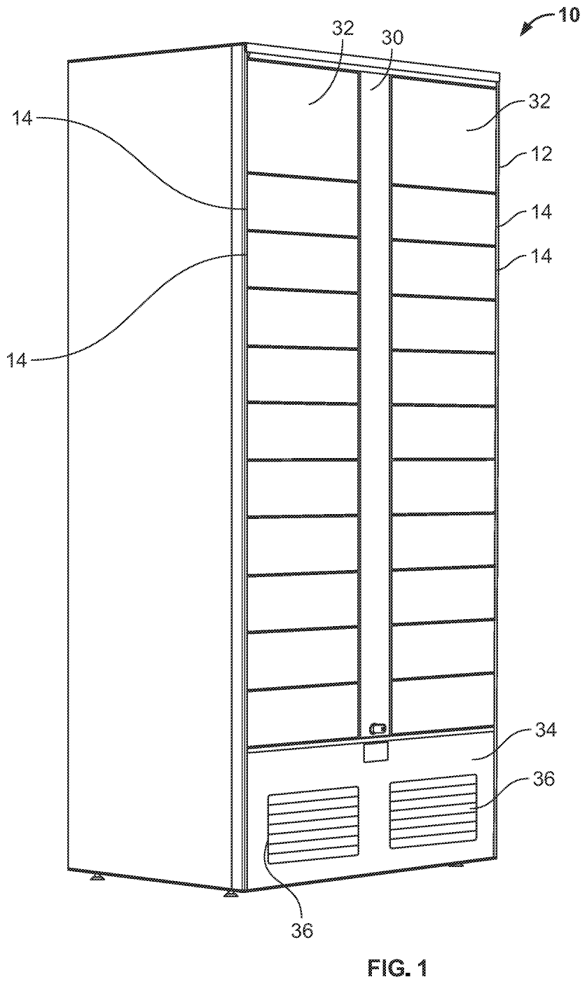

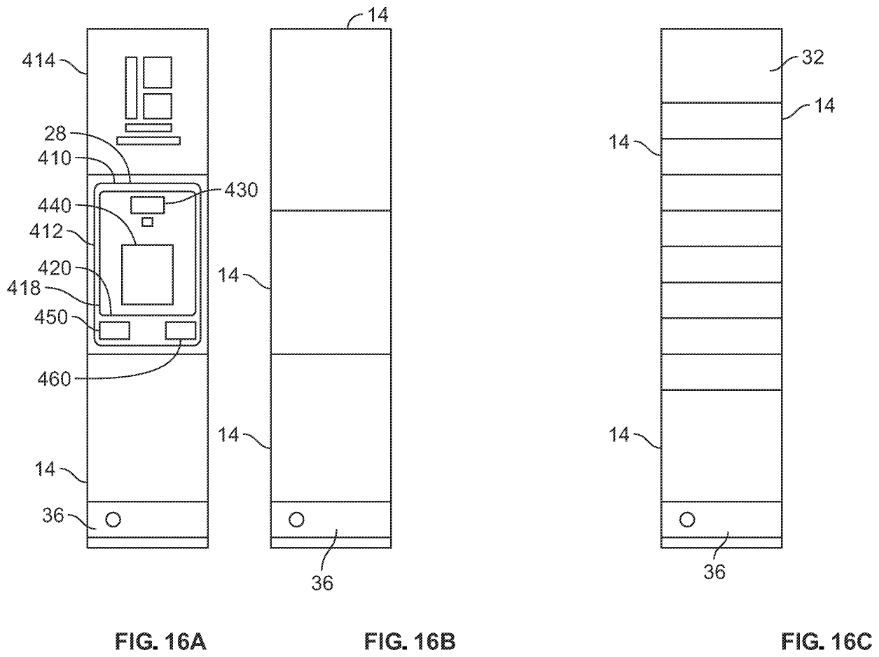

FIG. 1 shows an array of lockers 14 comprising an array of lockers, or locker bank, 12 adapted to provide a system 10 and method for charging and updating personal electronic equipment (PEE) such as, but not limited to, laptop or desk computers, tablet computers and smart phones. Although all of the lockers 14 shown in FIG. 1 are of the single high variety, other sizes of locker are contemplated by the disclosure as shown in FIGS. 16B and 16C. Moreover, locker sizes can be changed, for example by constructing the array of lockers using locker construction and systems described in the following patents and patent applications assigned to the common applicant and whose disclosures are incorporated herein by reference:
a. U.S. Pat. No. 11,410,118;
b. U.S. Pat. No. 10,643,415;
c. U.S. Pat. No. 10,915,415;
d. U.S. Pat. No. 11,144,873;
e. U.S. Pat. No. 11,210,889;
f. U.S. Pat. No. 11,270,251;
g. U.S. Pat. No. D954,481 Double Walled Locker Door; and
h. U.S. Pat. No. D984,183 Double Walled Locker Door

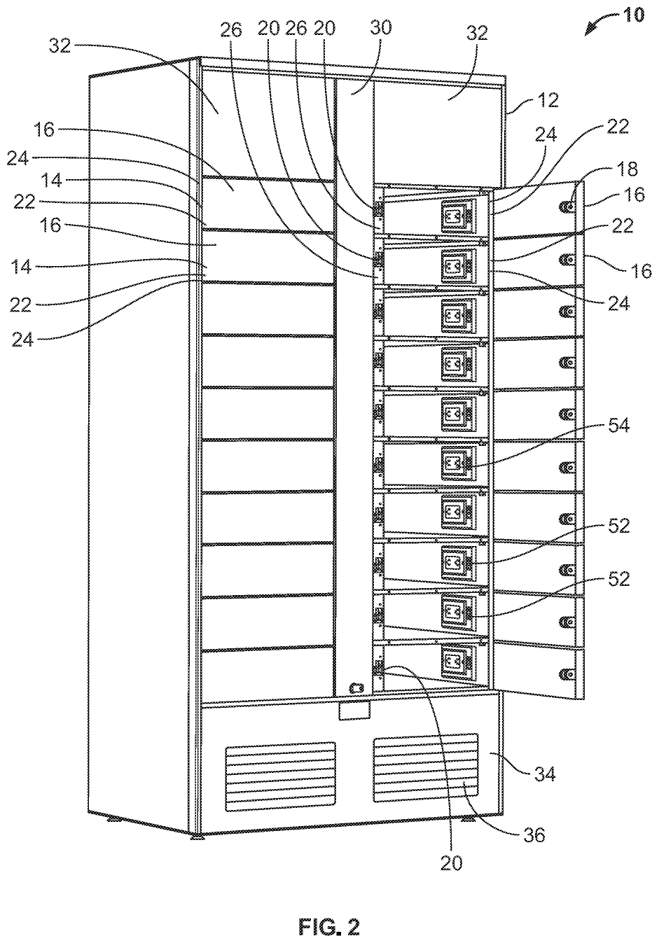

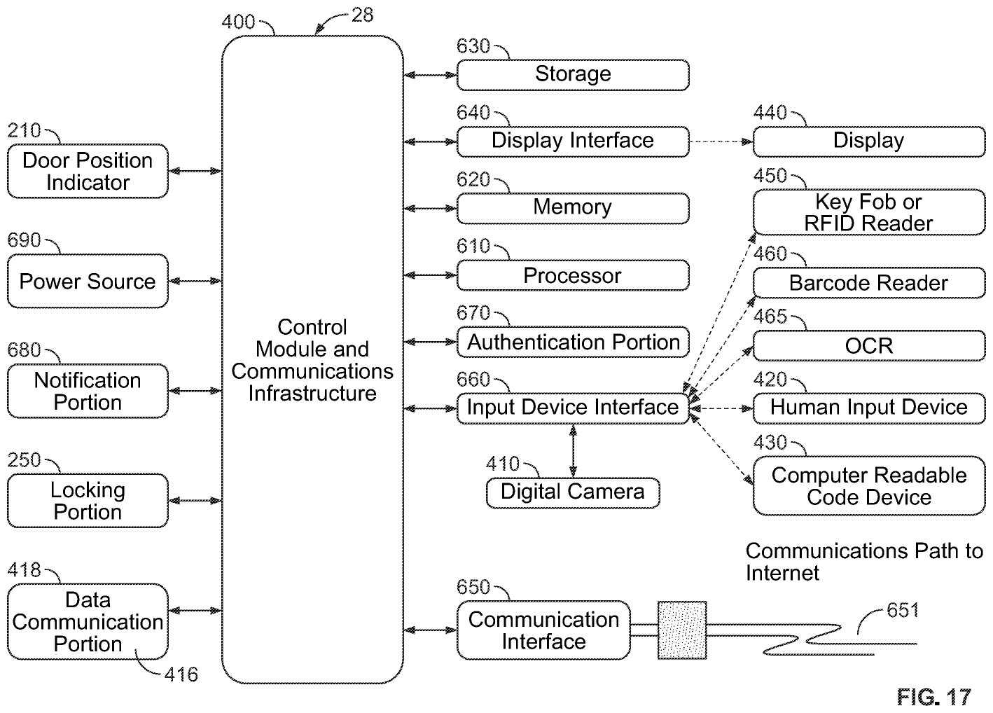

The array of lockers, or locker bank, 12 in FIGS. 1 and 2 shows a pair of columns of vertically aligned lockers 14. Each locker has a door 16 hingedly attached to a front end of a first side wall 24 by a hinge 22. Each door 16 also has a catch 18 that cooperates with a lock 20 associated with a front end of a second side wall 26. Each locker door 16 remains in the closed position by the lock 20 holding the catch 18 in a locked condition. The door is urged into an open position by a spring (not shown). The door is allowed to change from a closed condition to an open condition by an electrical signal to the lock 20 to release the catch 18 to an unlocked condition. Preferably, the electrical signal originates from a central control unit 28 as depicted in FIGS. 16A and 17 and more fully described hereinafter. Each door 16 is closed manually by a user by swinging the door 16 against the urging of the spring so the lock 20 can accept the catch 18. In one embodiment, each locker or locker door 16 has an alpha-numeric indicator on the outside for visual identification of the individual locker 14.

In a preferred embodiment, each column or vertical array of lockers 14 in the locker bank 12 comprises ten lockers. Each of the lockers 14 is sized to accept, for example, a laptop computer in a closed condition, a tablet or a smart phone type of PEE. In this embodiment, the lockers in the right array or column open to the right and the lockers in the left array or column open to the left. Accordingly, the hinges 22 are located in the front ends of a first side wall 24 proximate the right and left sides of the bank 12, and the locks are located in the front end of a second side wall 26 adjacent a vertical middle wall 30 that defines a space or air duct 44 of the locker bank 12. Each vertical column of the locker bank 12 may also have a top panel 32 that does not open, primarily because it is above the eyesight of the average user.

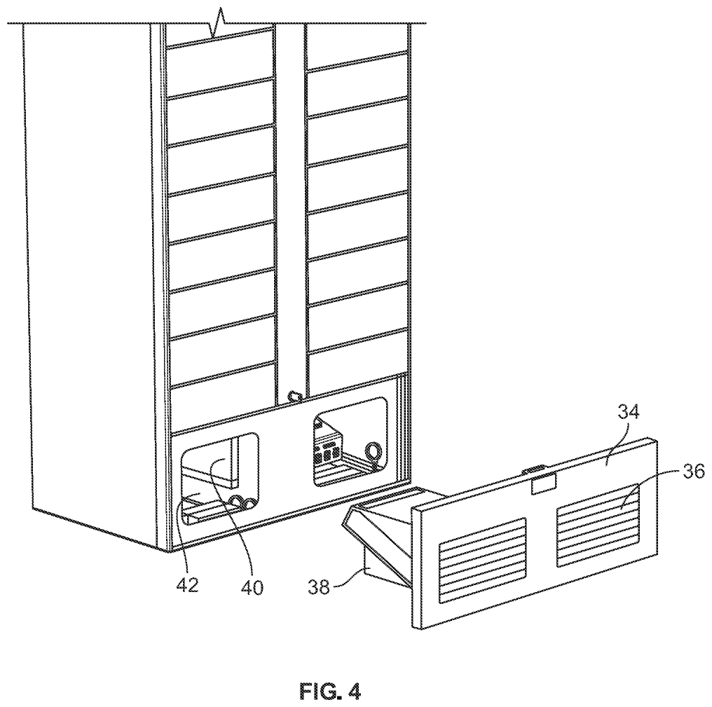

The locker bank 12 may also have a lower air space 42 fronted by a bottom panel or door 34 below the lowest locker in each vertical column. The bottom panel has at least one opening with louvers or vents 36 that allow air circulation into the interior of the locker bank 12 by means of an air circulator 38 (See FIGS. 4, 14 and 15). In another embodiment, as shown in FIGS. 16B and 16C, there are fewer lockers in each column, however, at least some lockers are taller vertically and have more volume. This embodiment may be useful for running and transferring data and software to, for example, a desktop computer, a server, or other larger PEE. Regardless of the size, each locker will have an electric power and data terminal 52. As seen in FIG. 16B, with the larger lockers, there may not be the need for a top panel 32 and the bottom panel may be smaller.

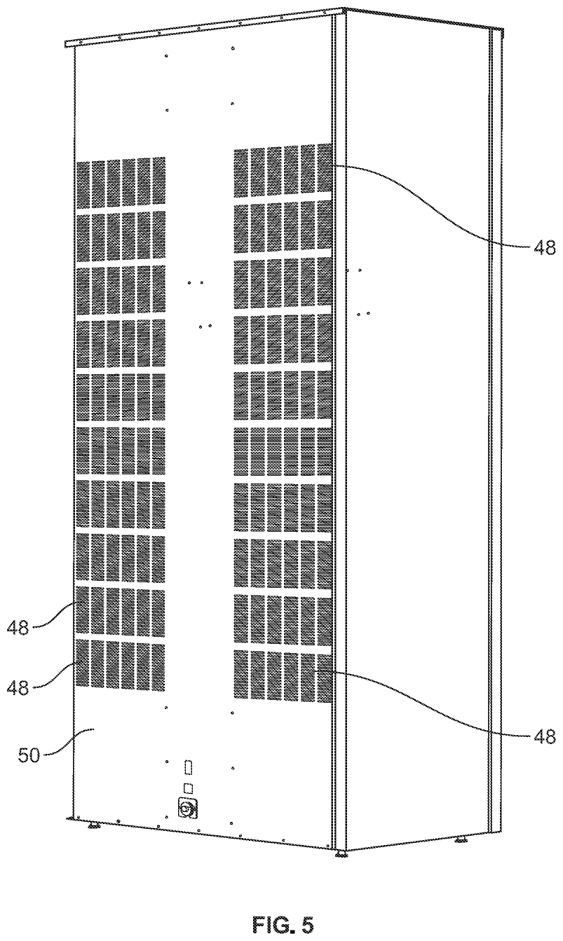

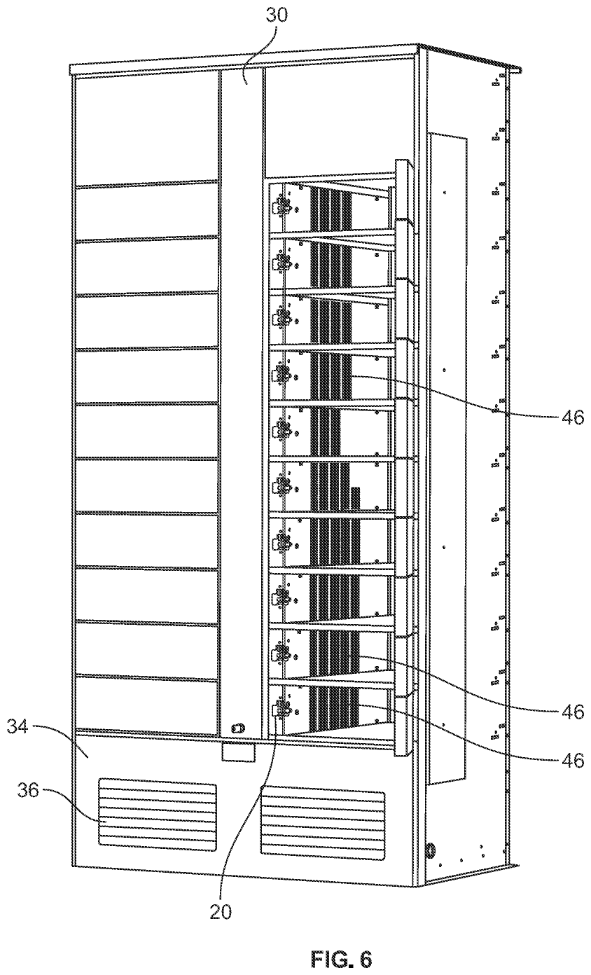

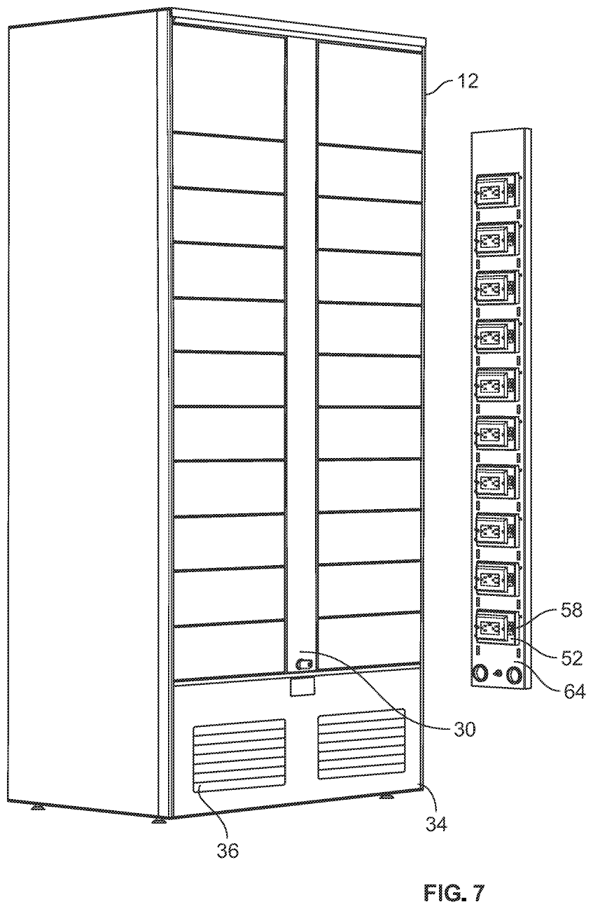

An air circulator 38 sucks in ambient air from in front of the locker bank through the vents 36 on the left side of the lower door or panel 34 and into the lower space or volume 42 behind the lower panel 34. A cutout 40 connects the lower volume 42 with a volume or vertical central space that acts as an air duct 44, adjacent the second side walls 26 and locks 20 for both columns of lockers 14. An opening such as a louver or vent 46 in the second side wall 26 of each locker 14 allows air to circulate from the central space air duct 44 into each of the lockers 14. The ambient air exits each of the lockers 14 through other openings such as vents or gratings 48 associated with each locker 14 in the rear wall 50 of the locker bank 12. See FIG. 5. By this construction, PEE being charged or having data transferred to it in a select locker 14 can be cooled by the ambient air entering one side of the locker 14 and exiting the back of the locker 14.

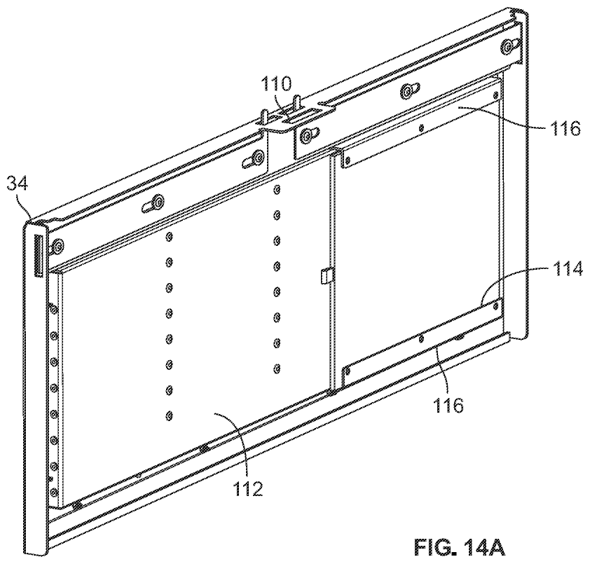

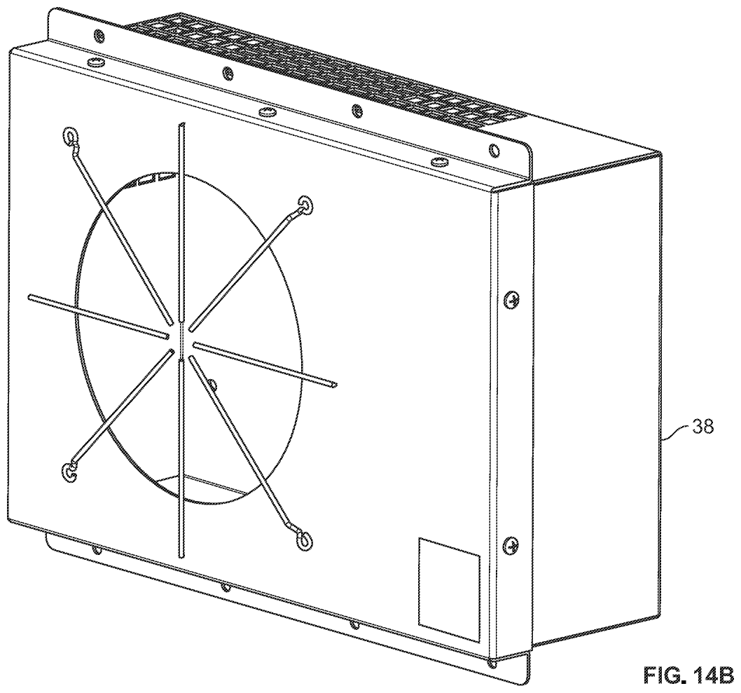

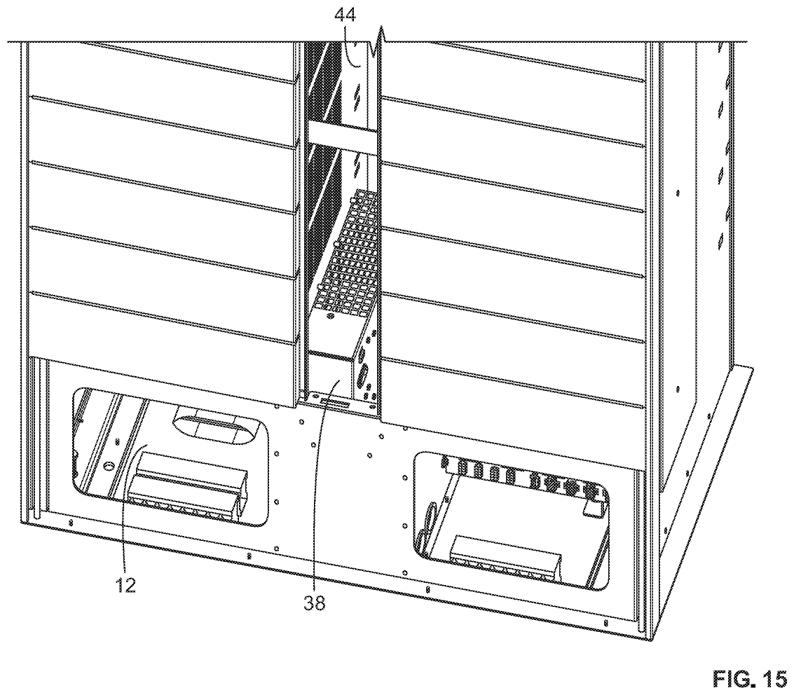

In one embodiment, as shown in FIG. 4, the air circulator is preferably an electrically powered fan attached to the back side of the panel 34 behind the louvers 36 and extending into the space 42, In another embodiment, as shown in FIGS. 14B and 15, the air circulator 38 is an electrically powered radial blower located in the lower portion of the air duct. Air from the lower air space 42 is sucked into the side of the blower and forced out the top of the blower into the air duct 44 for distribution to the lockers 14. One preferable radial blower unit is made by Ice Qube, Inc. or Greensburg, PA.

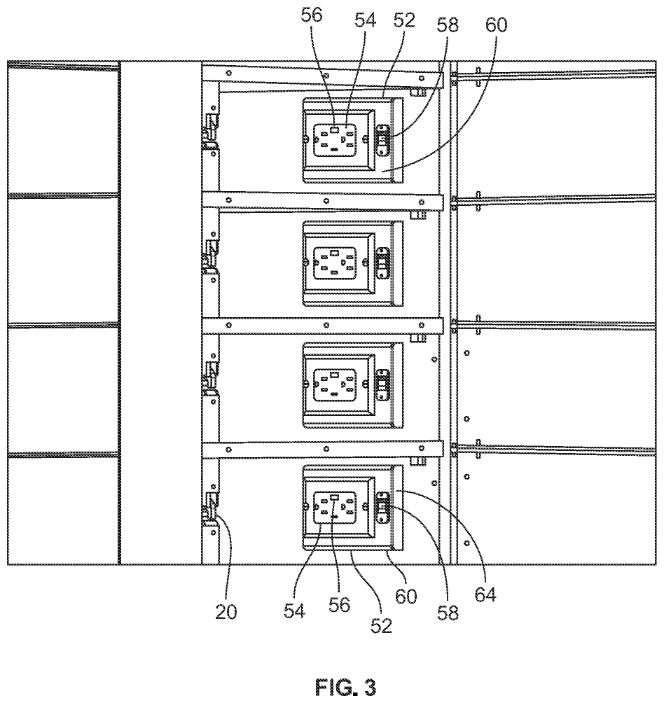

A modular individual locker electrical power and data terminal 52 is mounted on the first side wall 24 for each locker 14. See FIGS. 2, 3 and 8. Each power and data terminal has a power outlet 54 to provide electrical power to run the PEE in the locker or charge the battery of the PEE. In one embodiment, each terminal 52 has a 110-volt AC outlet 54 of appropriate amperage, having a positive, negative and ground outlet. When used with a step down transformer, the AC current from the outlet 54 is appropriate for charging the battery of a laptop, tablet or smart phone, or directly running a desktop, or server type PEE. In other embodiments, the AC outlet may be of a configuration, voltage and amperage to accommodate the standards in the respective country or locality in which the locker bank 12 is located, for example, 220 volts in the UK and EU. In one embodiment, the terminal 52 may also have a USB charging port 56 of appropriate voltage for charging, for example, a tablet or smart phone piece of PEE. The USB port 56 may be incorporated with the higher voltage outlet 54 or independent of the higher voltage outlet 54. In one embodiment, the USB or similar port 56 may also be used to transfer data to the PEE in the locker 14. Each terminal 52 also has an Ethernet or similar data transfer port 58 for transferring data or software to the PEE in the locker.

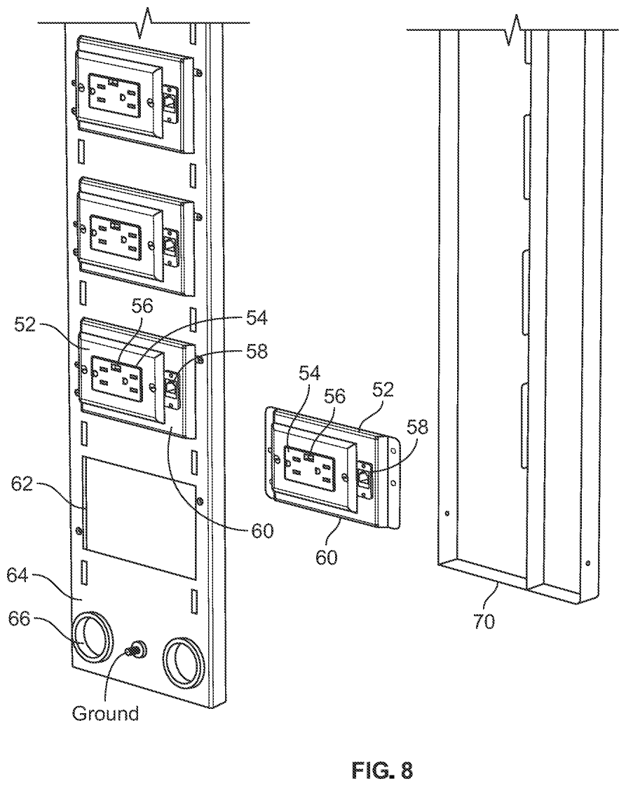

As best seen in FIG. 8, in one embodiment, each modular terminal 52 has an AC outlet 54, a USB outlet 56 and an Ethernet outlet 58 mounted on a metal plate 60. In some embodiments, the USB outlet may be eliminated or modified to a different location. Each plate 60 is in turn fastened to an elongated vertically oriented front plate 64 so that each terminal 52 extends through a complementary shaped aperture 62 in the elongated plate 64. After appropriate wires are connected to each terminal 52, an elongated vertical back plate 70 is attached to the front plate 64 to create a subassembly of modular terminals 52 to fit into or become the collective side walls of one column of lockers 14. Wires associated with each modular terminal 52 extend in the space between the front 64 and back 70 plates and through lower apertures 66 and into the lower space 42 behind the front lower panel 34. For lockers 14 that do not have a terminal 52, or larger lockers 14, a blank cover can be fastened over certain apertures 62.

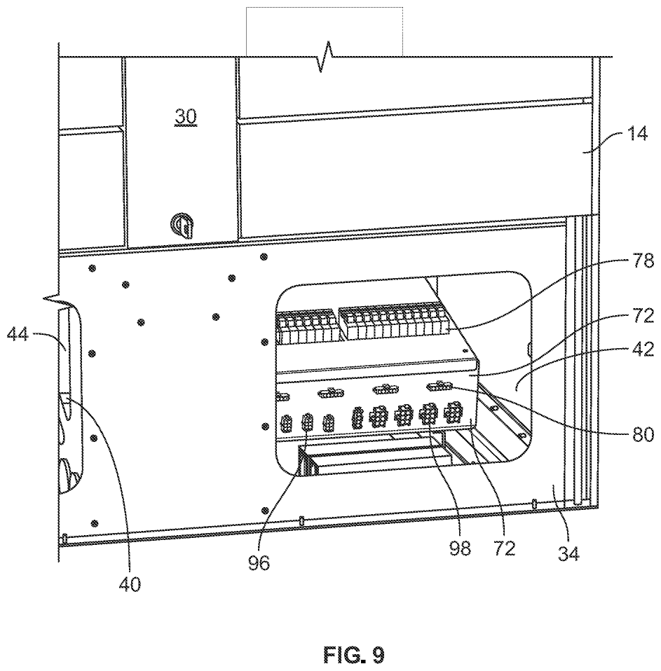

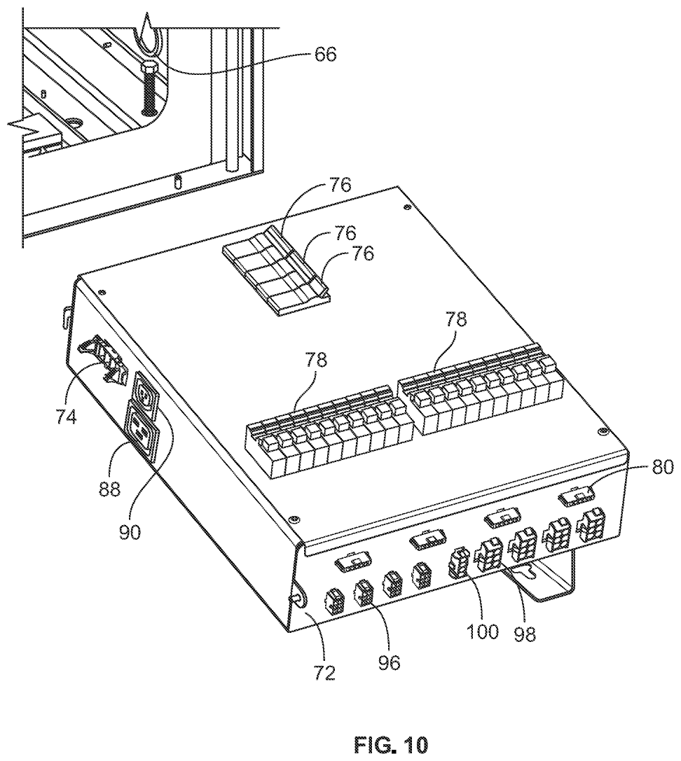

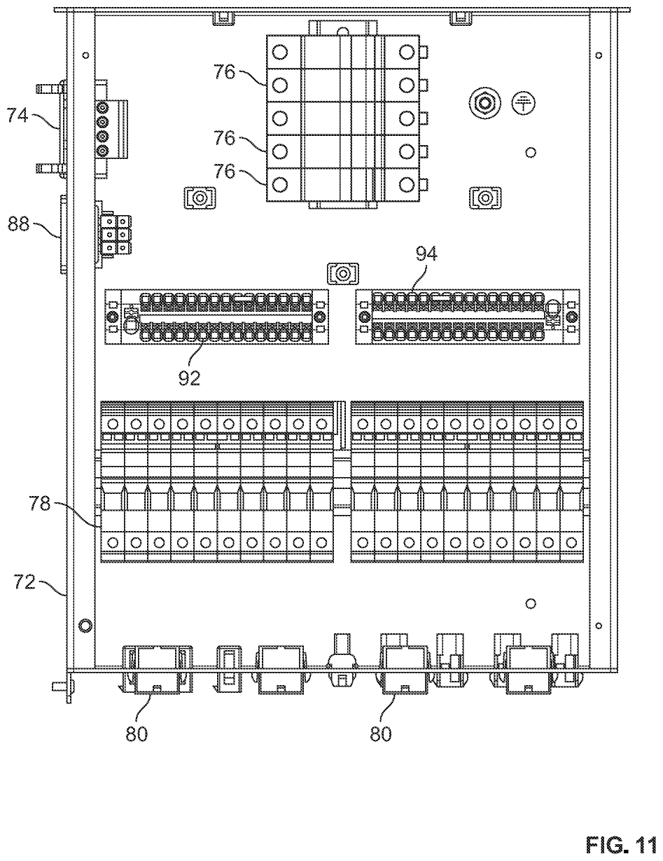

The wires supplying the electrical power to the AC 54 and, optionally USB or low voltage power ports 56 for each locker 14 terminate at the power terminal block 72 that is located in the lower space 42 behind the lower front panel 34 below the column of lockers opposite the air circulator or fan 38 in one embodiment. See FIG. 9. In other embodiments, the power terminal block may be located on either side of space 42 when the air circulator 38 is located in the central space or air duct 44 as shown in FIG. 15. As best seen in FIGS. 10 and 11, the power terminal block 72 has an electrical power inlet port 74, an air circulator power outlet port 88 and an Ethernet distribution panel power outlet 90 on one side. Master circuit breakers 76 for the locker AC power outlet ports, the air circulator and the Ethernet distribution panel are located near the back of the terminal block 72. An individual locker circuit breaker 78 is associated with the positive line for each locker in the locker bank. The negative line and ground line for each locker are connected to the respective negative terminal 92 and ground terminal 94. See FIG. 11.

The front wall of the terminal block 72 has a series of outlet plugs for positive or line voltage out 80, neutral return 96, and ground 98 wires for each AC 54 or USB 56 port for lockers 14. A ground wire to the chassis or frame of the locker bank may also be plugged into plug 100. Separate wiring, not shown, is used to activate and control the lock 20 associated with each locker 14. The power terminal block 72 is also cooled by ambient air circulated by the air circulator 38. With the modular construction of the power and data terminals 52 and subassemblies formed by the collection of terminals 52 and front 64 and back 70 plates, a generic locker bank 12 can be constructed and the specific configuration of AC, USB and Ethernet terminals added later by adding the specific subassemblies to the generic locker bank.

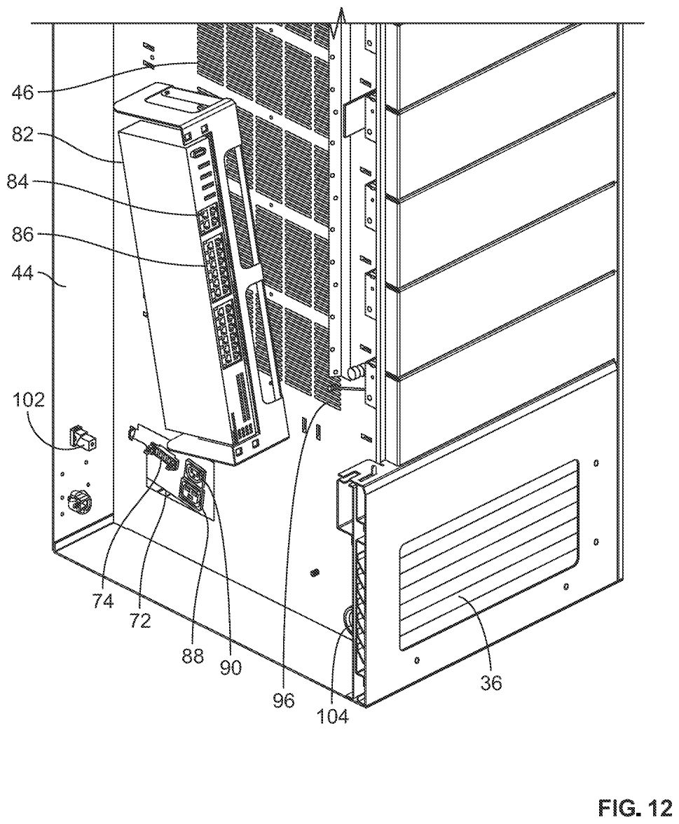

An Ethernet master data terminal 82 is preferably placed in the central space or air duct 44. It receives electrical power from wires associated with the Ethernet power outlet 90 on the power terminal block 72. The Ethernet data terminal 82 receives data and software signals through the Ethernet in plug 102 on the rear wall of the central space 44 to a data inlet port 84. These data and software signals can originate from the central control unit 28 or other electronic processors known in the art. Wires extend from data outlet ports 86 through aperture 104 and to each Ethernet port 58 associated with a locker 14 in the locker bank 12. See FIG. 12.

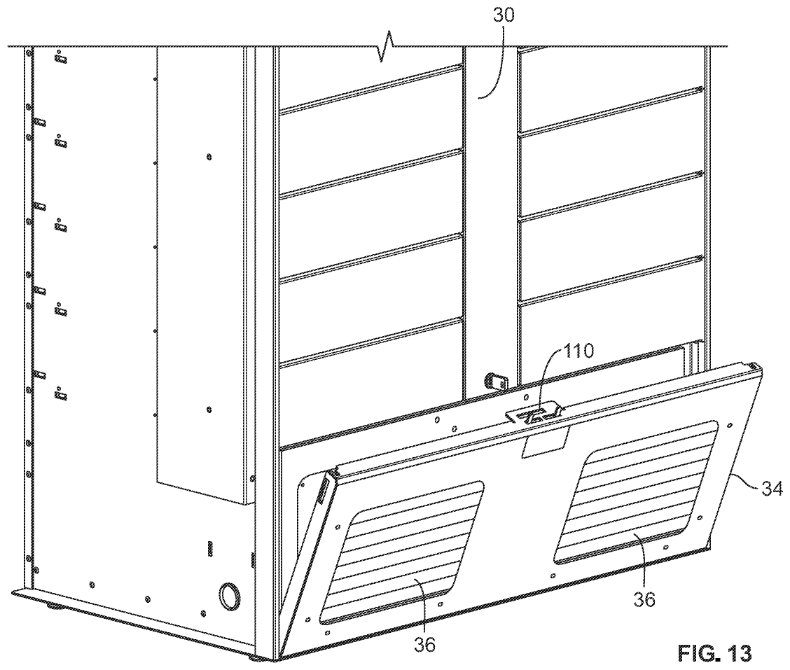

In another embodiment, as seen in FIGS. 13 and 14, the lower panel or door 34 is hinged at the bottom and has a lockable latch 110 at its top side. The door has a back wall 112 on the right side that covers the back side of the louvers 36 on the right side of the door 34 to restrict air ingress or egress through those louvers. The left side of the back wall 112 is a mounting arrangement 116 for an air filter 114 to filter incoming air. This embodiment is preferably used in conjunction with a radial air circulator 38 (see FIG. 14B) mounted in the central space or air duct 44.

### Central Control Unit

As noted earlier, the identification and control of the locks 20 and data or software transferred to PEE for each select locker 14 can be run through a central control unit 28. FIG. 16A illustrates one embodiment of a central control unit 28 in a frame 414 that may include at least one locker 14 and can easily be attached to or become a part of one column lockers of a locker bank 12, along with a non-limiting example of the components in a central control unit 28. At least portion of the central control unit could also be located remotely from the array of lockers, for example in the office of the department in charge of an organization's PEE, while the array of lockers and a more simplified input/output portion of the central control unit is in a more public area. The central control unit 28 uses a variety of components to control each of the locks 20 of the lockers 14, and identify and provide data and software to PEE in select lockers 14.

Optionally, the central control unit 28 in FIGS. 16A and 17 includes a kiosk 412 with a control module 400 having a data input portion 418 with input devices including at least a human input device 420 and a computer readable code device 430, processors 610, memory 620, storage 630, and a display device 440 connected to a display interface 640. The display device 440 can be a touchscreen and therefore operate as an input device. The central control unit 28 may also include a communications interface 650 for connecting to the Internet. The central control unit 28 further includes a locking portion 250, which connects the central control unit 28 to at least one lock 20 for a locker 14. The central control unit 28 also communicates with each Ethernet or data port 58 through a data communication portion 416, which may include a data output portion 418. The different components of the central control unit 28 are connected to each other by way of well-known communications infrastructure 660. The central control unit 28 provides power and commands to each locker 14 and can receive information from each locker 28.

The control module 400 of the central control unit 28 shown in FIG. 17 includes a plurality of input devices 410, 420, 430 and can include, for example, a still camera 410, an optical character reader (OCR) 465 a barcode reader 460, and a key fob or RFID reader 450. Other embodiments of the central control unit 28 include biometric sensors, audio sensors, other RFID sensors, proximity sensors, Bluetooth proximity sensors, near-field communication sensors, and other types of information collecting devices as input devices. Any number of input devices can be employed in a central control unit 28. The central control unit 28 uses these sensors in a variety of ways to collect the desired information from a user, from PEE, and from the environment and considers this information when making decisions. For example, it can act as an authenticator to verify the status of a person delivering or retrieving the PEE to and from a select locker 14 in the locker bank 12, and optionally decide which locker in which to place the select PEE associated with the authorized person. Input from an optional door position sensor 210 or a lock 20 provides the central control unit 28 information on the state of the door 16 for each locker 14. In addition, the central control unit 28 can use this information to control each of the locks 20.

The central control unit 28 can, in some embodiments, use aspects of the individual lockers 14 when controlling each of the locks 20. For example, the central control unit 28 can consider if the locking portion 250 indicates whether the locks 20 or the door position indicators 210 are providing status information that indicates the lock 20 is unlocked or locked, or the door 16 is open or closed before transmitting commands, such as a command to initiate a download of data or software to a PEE in a select locker 14. In a preferred embodiment, the control unit comprises, among other things, a camera 410, a display 440 that can also function as a human input device 420 and a barcode reader 460.

The central control unit 28 executes locker control software and provides a user interface on the display device 440 by controlling the display interface 640. The display interface 640 can also function as an input portion when the display device 440 is a touchscreen device. For example, the display device 440 or the input device 420 may include a list of types of PEE that can be accommodated by or are currently scheduled for the system 10. The person delivering the select PEE to the array of lockers can choose from the list and either the deliverer or the central control unit 28 can locate a locker to accommodate the select PEE to be delivered. It can be appreciated that the maximum use of the space allotted to the locker system 10 can only be achieved when the proper lockers are used with maximum frequency.

When referring to the central control unit 28, aspects can be executed by hardware components purposely built for executing these aspects, and other aspects can be executed by software components of the locker control software being executed on hardware components that perform multiple aspects. The user interface provides information to the user and requests input from the user through the input devices. The central control unit 28 can also provide audible feedback in response to input.

Information collected by sensors or data or power outlets in each of the individual storage lockers 14 is transmitted to the central control unit 28 for consideration by the locker control software. In some embodiments, the sensor information is preprocessed by an aspect of the locker 14 so that status information is transmitted to the central control unit 28. In some embodiments, other types of information can be considered by the central control unit 28 including information received from external sources over the Internet, and information received from authorized devices wirelessly connected to the central control unit 28. The central control unit 28 can, for example, wirelessly communicate with a device in a user's possession for authentication of the user. The user can also identify the PEE she is placing in a select locker and instruct the central control unit 28 to download the appropriate data or software to the PEE through the Ethernet port or data port 58.

The central control unit 28 uses the different information from the sensors to determine if an action is necessary. An action can include unlocking a locked storage locker 14, transmitting a notification, authenticating a user, responding to user input, communication with a PEE, updating the status of a storage locker 14, aggregating and remembering use of specific locker sizes over time, and other tasks needed to respond to sensor inputs as desired.

The central control unit 28 uses industry standard techniques and communication interfaces 650 to connect to the Internet. The central control unit 28 can use either wired or wireless networking technologies to establish the connection to the Internet. The central control unit 28 can operate by being directly connected to the Internet or by being connected to the Internet by way of a firewall.

Some embodiments of the central control unit 28 include a notification portion 680 for transmitting notifications to users. The notification portion 680 can use the connection 651 to the Internet when the type of notification transmitted is facilitated by using the Internet. The notification portion 680 can use other communications networks to transmit the notification. For example, the notification portion 680 can rely on a cellular network connection to transmit an SMS message to the user. The notification portion 680 can rely on other communications techniques using other communications networks such as Wireless Ethernet, ZigBee™, Bluetooth, and similar networks configured for a specific device or application. For example, the central control unit 28 can detect a particular smartphone within proximity of the notification portion 680, and then use the notification portion 680 to transmit to a smartphone when the smartphone is within range of the notification portion 680 to remind the user of the smartphone that their updated PEE is available for pick up. The notification portion 680 either can directly transmit the notification to the smartphone using a communications network, or the notification portion 680 can use the connection to the Internet to transmit a notification to the smartphone or other device.

Some embodiments of the central control unit 28, possibly through a central server, can also track the amount of time a PEE is stored in a storage locker 14. This is particularly applicable in situations where the system 10 is used in a location where the lockers 14 are provided as part of a service. The amount of time an individual PEE is stored in a locker 14 can also be used to determine if the data input time has expired. This occurs when a PEE has been stored in a locker 14 for a period of time that exceeds a predetermined period set by the locker bank owner. For example, an organization's IT personnel can then remove the time expired PEE from the system so that the locker 14 is again available for others to use.

In use, a system 10 and method for charging and updating data and software on select individual PEE's, includes a locker bank 12 that may be located in a common area of a large organization such as a corporation or a school. In one embodiment, persons in charge of maintaining the PEE for employees, agents and students of the organization will have special authorization to certain aspects of the central control unit 28. In another embodiment, all employees or students or individuals associated with the organization can obtain authorization from the select persons in charge or maintaining the PEE of the organization to become an authorized employee for their select PEE and interact with the central control unit. The authorization may be obtained from their PEE in a remote location through an internet connection to the central control unit, or through one of the input devices associated with the kiosk 412 or other control system associated with the locker bank 12.

The authorized employee can open a select locker 14 through communication with the central control unit 28, which unlocks the appropriate lock. The authorized employee then can place her select PEE in the locker and hook up a power cord from the power outlet port 54 and an Ethernet cable to the PEE from the Ethernet port 58. The authorized employee can then advise the central control unit of select PEE in the select locker and request that the central control unit update data and software on the PEE through the system. In one embodiment, this advice is done by communicating with the central control unit ahead of placing the select PEE in the locker.

At some point in one embodiment, the authorized employee also advises the central control unit 28 the identity of the new user of the PEE so that when the new data and software is downloaded onto the select PEE, the central control unit 28 can advise the new user that their PEE is newly updated and ready for pick up at the locker bank 12. In turn, the new user can identify herself to the central control unit 28, preferable through one of the input portions 418 or other input devices associated with the kiosk 412. When properly identified, the central control unit operates the lock 20 on the select locker 14 to allow the door 16 to open. With the locker door open, the new user can disconnect the PEE from the power 54 or 56 and data 58 ports and remove her PEE. Finally, the new user should be instructed to close the locker door 16 to allow the locker to be ready for the next user.

### Modifications

Although the above system has been described, modifications to the system are contemplated by this disclosure. In some embodiments, a nearfield communications device, Bluetooth device, or other wireless device can be used in order to identify a particular user instead of an RFID tag or a key fob.

Various embodiments disclosed herein are to be taken in the illustrative and explanatory sense, and should in no way be construed as limiting of the present disclosure. While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A system for charging and updating personal electronic equipment (PEE) comprising;
a. an array of lockers with each locker having an interior space defined by a floor, a ceiling, a rear end wall, first and second side walls and a door hingedly connected to the first side wall;
b. a lock in one side wall associated with each door for allowing the door to open when in the unlocked state and remain closed in the locked state;
c. a power outlet located in each locker for providing electrical power to a piece of PEE in the locker;
d. a data outlet port located in each locker for providing data and software to a select piece of PEE in the locker; and,
e. a central control unit adapted to control each of the locks on the array of lockers, the central control unit having a data output portion for sending data and software through the data outlet port in the select locker to the select PEE in the locker.

2. The system of claim 1 wherein the array of lockers also has a lower air space and an electrical power terminal block in the air lower air space for distributing electrical power to each locker power outlet.

3. The system of claim 1 wherein the central control unit also has a data input portion for receiving data on the select piece of PEE in the select locker.

4. The system of claim 2 wherein the array of lockers has an air circulator to provide ambient air to each of the lockers in the array, including a blower, a central air duct, one side wall of each locker adjacent the air duct having an air inlet to allow ambient air into the locker from the central air duct, and the rear end wall of each locker having an air outlet to allow air egress to the surrounding environment to cool a piece of PEE in the locker.

5. The system of claim 4 wherein the blower is located in the central air duct.

6. The system of claim 2 also having an Ethernet distribution panel in the central air duct for communicating with each locker data outlet port.

7. The system of claim 4 wherein the lower air space is partially defined by front panel and the blower is mounted on the front panel of the lower air space.

8. The system of claim 5 wherein the lower air space is partially defined by a front panel and the front panel has an air opening and an air filter adjacent the opening and wherein the ambient air enters the array of lockers through the front panel air opening.

9. The system of claim 6 wherein the array of lockers comprises two columns of lockers and also has wiring connecting the power terminal block with the power outlets in a first column of lockers and wiring connecting the Ethernet distribution panel with the data outlet ports in the lockers in the first column of lockers and the wiring, power outlets and data outlet ports are a modular unit.

10. An array of lockers comprising two columns of lockers and a central air duct between the columns and a lower air space below the lowest locker in each column, with each locker having an interior space defined by a floor, ceiling a rear end wall, first and second side walls and a door hingedly connected to the first side wall, a lock in the second side wall associated with each door for allowing the door to open when in the unlocked state and remain closed in the locked state, an electrical power outlet located in one side wall of each locker, a data outlet port also located in one side wall of each locker, an air inlet opening in one side wall of each locker and an air outlet opening in each rear end wall of each locker, and a blower in the central air duct for circulating air from the lower air space, through the central air duct, into each locker through each locker air inlet opening and out of each locker through the air outlet opening of each locker.

11. The array of lockers of claim 10 wherein the locker doors are spring biased into an open condition and also comprising a central control unit for controlling the locks on each locker to change the lockers from a locked to an unlocked condition.

12. The array of lockers of claim 11 wherein the lower air space is partially defined by a front panel and the front panel has an air opening and an air filter adjacent the air opening for filtering ingested air into the array.

13. A method of charging and updating the data and software on select personal electronic equipment (PEE) in a select locker comprising:
a. providing an array of lockers with each locker having an interior space defined by a floor, a ceiling, a rear end wall, first and second side walls and a door hingedly connected to the first side wall, a lock in the second side wall associated with each door for allowing the door to open when in the unlocked state and remain closed in the locked state, a power outlet located in each locker for providing electrical power to a piece of PEE in the locker, a data outlet port located in each locker for providing data and software to a select piece of PEE in the locker, and a central control unit adapted to control each of the locks on the array of lockers, the central control unit also having a data input portion and a data output portion for sending data and software through the data outlet port in a select locker to a select PEE in a select locker while the associated door for that locker is closed;
b. advising the input portion of the central control unit of a select PEE in need of updated software or data;
c. the central control unit unlocking the door of a select locker;
d. inserting the select PEE into the select locker and connecting it to the power outlet and the data outlet port in that locker; and,
e. closing the door.

14. The method of claim 13 wherein upon closing the door, the data output portion of the central control unit provides the updated software and data to the select PEE though the data outlet port in the select locker.

15. The method of claim 14 also comprising retrieving the select PEE after it has had its software and data updated by communicating with the data input portion of the central control unit, and the central control unit outlet portion unlocking the select locker.
